(19) United States
(12) Patent Application Publication
(10) Pub. No.: US 2004/0183947 A1
(43) Pub. Date: Sep. 23, 2004

(54) Apparatus and method for displaying signal strengths of every channel of digital broadcast receiver

(75) Inventor: Hwal Rim Lee, Seoul (KR)

Correspondence Address: JONATHAN Y. KANG, ESQ., LEE & HONG P.C., 11th Floor, 221 N. Figueroa Street, Los Angeles, CA, 90012-2601, US

(73) Assignee: LG Electronics, Inc.

(21) Appl. No.: 10/802,162

(22) Filed: Mar. 16, 2004

(30) Foreign Application Priority Data
Mar. 17, 2003 (KR) 16441/2003

(51) Int. Cl. H04N 17/00

(52) U.S. Cl. 348/570; 348/184

(57) ABSTRACT

An apparatus and method for display signal strengths of every channel of a digital broadcast receiver are disclosed. Channels for broadcast signals are sequentially scanned from a tuner receiving a digital broadcast signal, and channel numbers, the number of channels, signal strengths of each channel, and the sum of signal strengths of the entire channels are outputted in an OSD (On Screen Display) form or as a voice. Thus, a user can objectively set an optimum direction of an antenna for every channel.

### BACKGROUND OF THE INVENTION

1. Field of the Invention

The present invention relates to a digital broadcast receiver and, more particularly, to an apparatus and method for display signal strength of every channel of a digital broadcast receiver capable of receiving an optimum broadcast signal in receiving a digital broadcast.

2. Description of the Background Art

In general, unlike the existing analog broadcast, a digital broadcast is the next-generation broadcast technology for converting information such as an image, a voice or data into a digital signal (expressing information by 0 and 1) form and transmitting it. Accordingly, a large amount of information can be easily transferred through a compression technique, and when a signal is transmitted, the signal is not much affected by noise or distortion, and even if the signal is damaged, it can be perfectly restored, so that viewers can view a program with the same quality as that a broadcasting station sends.

In such a digital multi-channel broadcast, in order for viewers to effectively view information broadcast by various channels, an electronic program guide (EPG) providing information on a content of a broadcast program or the like. Accordingly, users can view a broadcast program with reference to menus of the EPG.

For example, after an antenna is installed to receive a digital satellite broadcast, a direction of the antenna is set, and then, scanning is performed for an optimum broadcast receiving. Thereafter, the direction of the antenna is changed to receive an optimum broadcast signal according to the scanning result, and then, scanning is repeatedly performed to fix the antenna in a direction of a broadcast signal that is considered to be optimum. Namely, the direction of the antenna in which an optimum broadcast signal can be received for a specific channel can be known by rotating the antenna through scanning.

However, the direction of the antenna in which the optimum broadcast signal can be received may differ for each channel, and it is difficult to set the direction of the antenna whenever a channel is changed.

In other words, in the conventional digital broadcast receiver, setting of the direction of the antenna having an optimum signal strength needs user's subjective judgment and comparison, so the following problems arise.

That is, when scanning is performed on channels, the antenna must be rotated several times in order to take a direction of the antenna most suitable for each channel by a subjective judgment or signal strengths of each channel must be checked one by one upon changing channels. Thus, since the user's subjective judgment is involved, the direction of the antenna may be inaccurate, and in addition, much time is taken for the repeated comparison and adjustment, increasing users' inconvenience.

### SUMMARY OF THE INVENTION

Therefore, an object of the present invention is to provide an apparatus and method for displaying signal strengths of every channel of a digital broadcast receiver capable of receiving an optimum broadcast signal for each channel by displaying the strength of a broadcast signal of each channel in an OSD form on a screen in broadcasting a digital broadcast.

To achieve these and other advantages and in accordance with the purpose of the present invention, as embodied and broadly described herein, there is provided an apparatus for displaying a signal strength of each channel of a digital broadcast receiver including: a signal strength searching unit for searching a signal strength of a channel for a broadcast signal being currently tuned; a decoding unit for outputting a value of the signal strength searched by the signal strength searching unit as a video signal; and a microcomputer for controlling the decoding unit to display a signal strength of a channel according to the signal strength searched by the signal strength searching unit on a screen.

To achieve the above object, there is also provided a method for displaying a signal strength of each channel of a digital broadcast receiver, including: sequentially scanning channels for digital broadcast signals from a tuner receiving the digital broadcast signals; and displaying channel numbers of the scanned channels, the number of channels, signal strengths of each channel, and sum of the signal strengths of the entire channels in an OSD (On Screen Display) form.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1A is an exemplary view showing a screen of a digital broadcast receiver displaying channel information according to channel scanning in accordance with the present invention;

FIG. 1B is an exemplary view showing a screen displaying channel information on the entire channels after completing channel scanning in accordance with the present invention;

FIG. 2 is a schematic block diagram of a digital broadcast receiver in accordance with the present invention; and

FIG. 3 is a flow chart of a method for displaying a signal strength of each channel in accordance with the present invention.

### DETAILED DESCRIPTION OF THE PREFERRED EMBODIMENTS

Reference will now be made in detail to the preferred embodiments of the present invention, examples of which are illustrated in the accompanying drawings.

An apparatus and method for displaying every channel signal strength of digital and satellite broadcast receiver (referred to as ‘digital broadcast receiver’, hereinafter) capable of setting a direction of an antenna in order to receive an optimum broadcast signal for every channel by displaying a broadcast signal strength of every channel in receiving a digital broadcast, in accordance with a preferred embodiment of the present invention will now be described with reference to the accompanying drawings.

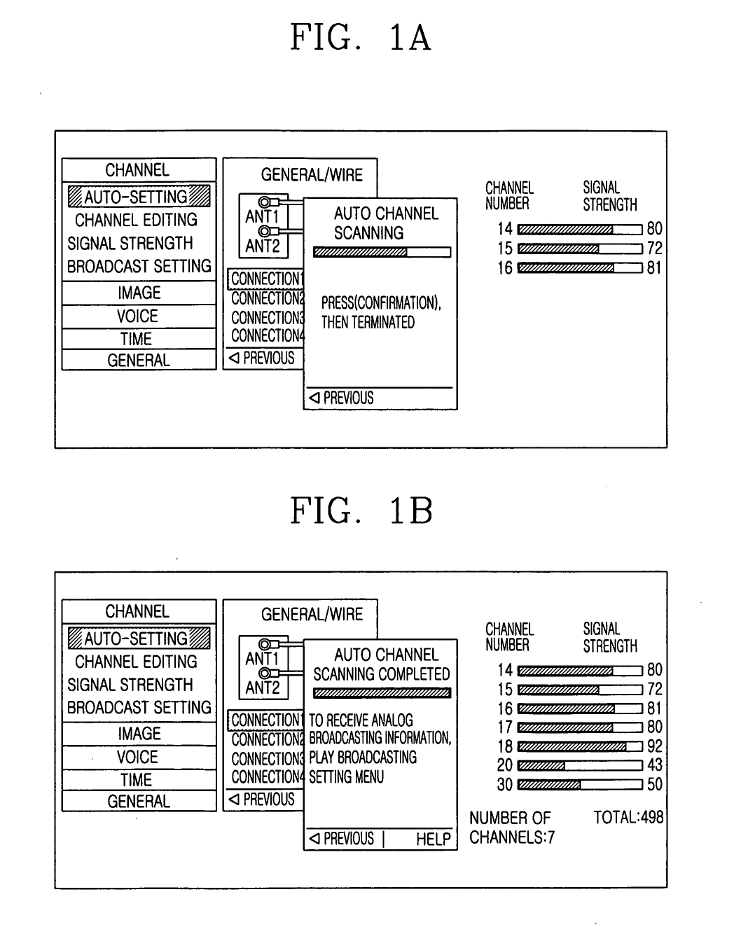

FIG. 1A is an exemplary view showing a screen of a digital broadcast receiver displaying channel information according to channel scanning in accordance with the present invention, and FIG. 1B is an exemplary view showing a screen displaying channel information on the entire channels after completing channel scanning in accordance with the present invention.

As shown in FIGS. 1A and 1B, the digital broadcast receiver in accordance with the present invention displays signal strengths of every channel scanned through an auto channel scanning in an OSD form. Thus, the user can objectively set a direction of an antenna in order to receive an optimum broadcast signal for every channel.

This will now be described in detail.

First, in the digital broadcast receiver in accordance with the present invention, a physical channel number (major and minor channel numbers can be also displayed) for a channel scanned during auto scanning of a digital broadcast and a signal strength of the channel can be displayed as a diagram and a numeral in an OSD form on the screen. In this case, it can be set such that signal strengths of every channel are displayed according to channels provided in the electronic program guide, and it is preferred that only scanned channel appears through the auto scanning. For example, in case of the digital broadcast, channels exist in a major and minor form in view of characteristics of virtual channels, and thus, the channels in the major and minor form are mobile, not fixed.

After the auto channel scanning is completed as shown in FIG. 1B, channel numbers of scanned channels, the number of channels, signal strengths of each channel and the sum of signal strengths of the entire channels are displayed in the OSD form on the screen of the digital broadcast. Accordingly, the user can use such information as objective data to detect an optimum direction of the antenna in installing the antenna.

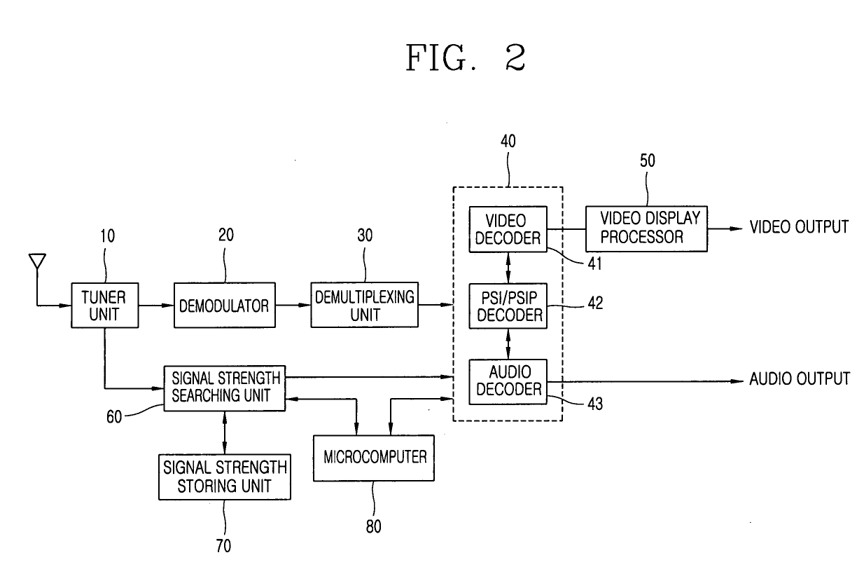

FIG. 2 is a schematic block diagram of a digital broadcast receiver in accordance with the present invention.

The digital broadcast receiver in accordance with the present invention includes: a tuner unit 10 for receiving a digital broadcast signal and outputting it in a transmission stream form; a demodulator 20 for decoding the transmission stream received through the tuner unit and correcting an error; a signal strength searching unit 60 for searching a signal strength of a channel being currently tuned by the tuner unit; a storing unit 70 for storing a value of the signal strength searched by the signal strength searching unit; a demultiplexing unit 30 for extracting audio, video and additional data from the transmission stream received through the demodulator; a decoding unit 40 for decoding the audio, video and the additional data extracted by the demultiplexing unit 30 to output audio, video and additional data signal, and outputting the value of the signal strength searched by the signal strength searching unit as a video signal; a video display processor (VDP) 50 for converting the video signal outputted from the decoding unit into a form suitable to be outputted to a screen; and a microcomputer 80 for controlling the decoding unit to search a user's desired signal strength from the signal strength searching unit and display a signal strength of a channel according to the searched signal strength.

The decoding unit 40 includes a video decoder 41 for decoding the video data extracted by the demultiplexing unit 30 and outputting a video signal; an audio decoder 43 for decoding audio data extracted by the demultiplexing unit and outputting an audio signal; and a PSI/PSIP decoder 42 for decoding the additional data extracted by the demultiplexing unit and outputting an additional data signal.

The digital broadcast receiver operates as follows.

First, the demodulator 20 decodes a transmission stream received through the tuner unit 10 to correct an error, and outputs the decoded transmission stream to the demultiplexing unit 30. Then, the demultiplexing unit 30 extracts audio, video and additional data from the transmission stream received through the demodulator 20, and outputs it to the decoding unit 40. The decoding unit 40 decodes the audio, video and additional data extracted by the demultiplexing unit 30 and outputs an audio, video and additional data signal.

The microcomputer 80 controls the signal strength searching unit 60 to search a user's desired signal strength, and controls the searched signal so that channel numbers, the number of channels, signal strengths of each channel and the sum of the signal strengths of the entire channels can be displayed in an OSD form or outputted as a voice.

In other words, the microcomputer 80 controls the decoding unit 40 to search a signal strength desired by the user from the signal strength searching unit 60 and display a signal strength of a channel according to the searched signal strength. In addition, the microcomputer 80 controls the video display processor 50 to display the video signal outputted form the decoding unit 40 as a picture or a numeral on the screen, or controls the audio decoder 43 to output a voice.

The transmission stream received through the tuner unit 10 includes also a PSIP (Program and System Information Protocol) as well as an audio/video packet, from which information on programs of each channel can be known. That is, a content of packetized audio and video information can be viewed with the PSIP information. The PSIP information includes an MGT (Master Guide Table), a TVCT (Terrestrial Virtual Channel Table), an RRT (Rating Region Table), an EIT (Event Information Table), an ETT (Extended Text Table), an SST (System Time Table), and the like.

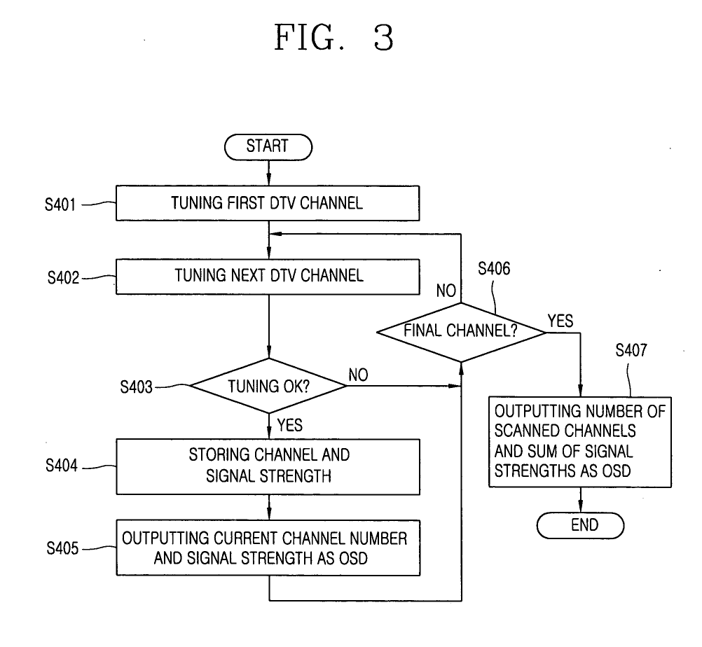

FIG. 3 is a flow chart of a method for displaying a signal strength of each channel in accordance with the present invention.

With reference to FIG. 3, the method for display signal strengths of every channel of a digital broadcast receiver in accordance with the present invention will now be described.

Channels for broadcast signals are sequentially scanned from the tuner unit 10 receiving a broadcast signal (steps S401, S402 and S403). And then, the sequentially scanned channel information and the signal strength of the channel are stored (step S404) and sequentially outputted on the screen (step S405). It is determined whether the scanned channel is a final channel (step S406). If the scanned channel is not the final channel, the series of processes as described above are repeatedly performed. If, however, the scanned channel is the final channel, the number of channels detected in the channel scanning process and the sum of signal strengths are outputted on the screen or outputted as a voice (step S407).

Accordingly, in the present invention, in the course of the auto channel scanning or when the auto channel scanning is completed, a list of the searched channels and signal strengths of each channel are outputted on the screen for user's easy recognition or as a voice. Therefore, the user can effectively recognize a current signal state.

As so far described, the apparatus and method for display signal strength of every channel of a digital broadcast receiver have the following advantages.

That is, for example, since the auto channel scanning is performed and signal strengths of every searched channel are outputted in an OSD form or as a voice for user's information, the user can objectively know an optimum direction of the antenna. Namely, since the channel numbers, the number of channels, signal strengths of each channel and the sum of signal strengths of the entire channels can be known, an optimum receiving environment can be provided.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A method for displaying signal strengths of each channel of a digital broadcast receiver, comprising:
sequentially scanning channels for digital broadcast signals from a tuner receiving the digital broadcast signals; and
displaying channel numbers of the scanned channels, the number of channels, signal strengths of each channel, and sum of the signal strengths of the entire channels in an OSD (On Screen Display) form.

2. The method for displaying signal strengths of claim 1 further comprising:
storing the sequentially scanned channel information and signal strengths of each channel.

3. The method for displaying signal strengths of claim 1, wherein the channel numbers of the scanned channels, the number of channels, signal strengths of each channel, and sum of the signal strengths of the entire channels for the searched channels are outputted as a voice.

4. The method for displaying signal strengths of claim 1, wherein, in the channel scanning, signal strengths of every channel are displayed in the OSD form through an auto channel scanning.

5. The method for displaying signal strengths of claim 1, wherein the signal strengths of each channel are displayed in picture and numerals.

6. The method for displaying signal strengths of claim 1, wherein the broadcast signal received through the tuner includes audio, video and PSIP (program and System Information Protocol) data.

7. A method for displaying signal strengths of each channel of a digital broadcast receiver, comprising:
sequentially scanning channels for broadcast signals from a tuner receiving broadcast signals;
storing the sequentially scanned channel information and signal strengths of each channel;
sequentially outputting the sequentially scanned channel information and signal strengths of each channel to a screen;
determining whether the scanned channel is a final channel, and repeatedly performing the series of steps as described above if the scanned channel is not the final channel; and
determining whether the scanned channel is the final channel, and outputting the number of channels scanned through the channel scanning step and the sum of signal strengths in an OSD form on the screen.

8. The method for displaying signal strengths of claim 7, wherein, in the step of outputting in the OSD form, channel numbers, the number of channels, signal strengths of each channel and the sum of signal strengths of the entire channels for the scanned channels are outputted as a picture, a numeral or a voice.

9. An apparatus for displaying signal strengths of each channel of a digital broadcast receiver comprising:
a signal strength searching unit for searching a signal strength of a channel for a broadcast signal being currently tuned;
a decoding unit for outputting a value of the signal strength searched by the signal strength searching unit as a video signal; and
a microcomputer for controlling the decoding unit to display a signal strength of a channel according to the signal strength searched by the signal strength searching unit on a screen.

10. The apparatus for displaying signal strengths of claim 9 further comprising:
a signal strength storing unit for storing the signal strength values searched by the signal strength searching unit; and
a video display processor for converting the video signal outputted from the decoding unit to such a suitable form as to be outputted to a screen.

11. The apparatus for displaying signal strengths of claim 9 further comprising:
a tuner unit for receiving a digital broadcast signal and outputting it in a transmission stream form;
a demodulator for decoding the transmission stream received through the tuner and correcting an error; and
a demultiplexing unit for extracting audio, video, additional data and the like from the transmission stream received through the demodulator.

12. The apparatus for displaying signal strengths of claim 11, wherein the decoding unit decodes the audio, video and additional data extracted by the demultiplexing unit to output an audio, video and additional data signal, and outputs signal strength values searched by the signal strength searching unit as a video signal.

13. The apparatus for displaying signal strengths of claim 12, wherein the microcomputer controls the decoding unit to output channel numbers, the number of channels, signal strengths of each channel, and the sum of signal strengths of the entire channels as a voice.

14. The apparatus for displaying signal strengths of claim 11, wherein the decoding unit comprises:
a video decoder for decoding the video data extracted by the demultiplexing unit and outputting a video signal;
an audio decoder for decoding the audio data extracted by the demultiplexing unit and outputting an audio signal; and
a PSI/PSIP decoder for decoding the additional data extracted by the demultiplexing unit and outputting an additional data signal.

15. The apparatus for displaying signal strengths of claim 9, wherein the microcomputer searches a user's desired signal strength from the signal strength searching unit and controls the searched signal so as to be displayed on the screen.

16. The apparatus for displaying signal strengths of claim 15, wherein the microcomputer displays the channel numbers, the number of channels, signal strengths of each channel, and the sum of signal strengths of the entire channels.

17. An apparatus for displaying signal strengths of each channel of a digital broadcast receiver comprising:
a tuner unit for receiving a digital broadcast signal and outputting it in a transmission stream form;
a demodulator for decoding the transmission stream received through the tuner and correcting an error;
a signal strength searching unit for searching a signal strength of a channel being currently tuned by the tuner unit;
a signal strength storing unit for storing the signal strength value searched by the signal strength searching unit;
a demultiplexing unit for extracting audio, video, additional data or the like from the transmission stream received through the demodulator;
a decoding unit for decoding the audio, video and additional data extracted by the demultiplexing unit to output an audio, video and additional data signal, and outputting the signal strength value searched by the signal strength searching unit as a video signal;
a video display processor (VDP) for converting the video signal outputted from the decoding unit to such a suitable form as to be outputted to a screen; and
a microcomputer for controlling the decoding unit to search a user's desired signal strength form the signal strength searching unit and outputting a signal strength of a channel according to the searched signal strength.

18. The apparatus for displaying signal strengths of claim 17, wherein the decoding unit comprises:
a video decoder for decoding the video data extracted by the demultiplexing unit and outputting a video signal;
an audio decoder for decoding the audio data extracted by the demultiplexing unit and outputting an audio signal; and
a PSI/PSIP decoder for decoding the additional data extracted by the demultiplexing unit and outputting an additional data signal.

19. The apparatus for displaying signal strengths of claim 17, wherein the microcomputer controls the decoding unit to output the channel numbers, the number of channels, signal strengths of each channel, and the sum of signal strengths of the entire channels, as a voice.

20. The apparatus for displaying signal strengths of claim 17, wherein the microcomputer controls the decoding unit to display the channel numbers, the number of channels, signal strengths of each channel, and the sum of signal strengths of the entire channels, in an OSD form on a screen.
